(19) United States
(12) Patent Application Publication
(10) Pub. No.: US 2017/0141487 A1
(43) Pub. Date: May 18, 2017

(54) METHOD FOR JOINING TERMINAL AND ELECTRIC WIRE AND ELECTRIC WIRE CONNECTION TERMINAL

(71) Applicant: TABUCHI ELECTRIC CO., LTD., Osaka-shi (JP)

(72) Inventors: Akimasa TAMURA, Osaka-shi (JP); Takenori KUNIMI, Osaka-shi (JP); Nobuhito KYO, Osaka-shi (JP); Sachihiko SHINDO, Osaka-shi (JP); Takehiko ADACHI, Osaka-shi (JP)

(73) Assignee: TABUCHI ELECTRIC CO., LTD., Osaka-shi (JP)

(21) Appl. No.: 15/419,150

(22) Filed: Jan. 30, 2017

Related U.S. Application Data
(63) Continuation of application No. PCT/JP2014/070264, filed on Jul. 31, 2014.

(51) Int. Cl. H01R 4/18; H01R 11/12; H01R 43/048; H01R 4/62; H01R 43/02

(52) U.S. Cl. CPC H01R 4/187; H01R 4/625; H01R 43/02; H01R 43/048; H01R 4/184; H01R 11/12

(57) ABSTRACT

A method of the present invention includes: electrically joining an electric wire 5 and a terminal (1) by crimping the electric wire 5 held by a first crimp piece (6) under a stress condition where external force is applied; and mechanically joining the terminal (1) and the electric wire (5) by soldering the electric wire (5) held by a second crimp piece (7) onto the terminal (1) while heating the electric wire (5) under a stress-free condition where no external force is applied by applying an electric current to heating electrodes (10, 12). The terminal (1) that is made of a different material from the electric wire (5) is surface-treated in order to avoid electric corrosion with the electric wire (5).

### CROSS REFERENCE TO THE RELATED APPLICATION

This application is a continuation application, under 35 U.S.C. §111 (a) of international application No. PCT/JP2014/070264, filed Jul. 31, 2014.

### BACKGROUND OF THE INVENTION

Field of the Invention

The present invention relates to a method for joining a terminal and an electric wire, and a terminal for electric wire connection, in a case where the terminal and the electric wire are made of different materials.

Description of Related Art

Conventionally, an electric wire made of copper or a copper alloy is often used. Meanwhile, aluminum or an aluminum alloy has good electric conductivity and is lighter in weight and lower in cost than copper and the like, and therefore there are a lot of advantages when aluminum or the like is used for an electric wire.

However, in a case where aluminum or the like is used for an electric wire, the electric wire needs to be joined to a terminal made of a different material such as copper or a copper alloy. At this time, the electric wire might be corroded because of occurrence of electric corrosion between the electric wire and the terminal.

In view of this, conventionally, a crimping connection structure having an improved electric corrosion prevention function is known as a watertight sealing structure in which an aluminum wire is connected to a terminal metal fitting by crimping and then the whole crimped part is subjected to hot melt molding (see, for example, Patent Document 1).

Meanwhile, a terminal structure in which an electric wire and a terminal are joined together by pressurizing an insulation-coated electric wire nipped by heating electrodes (e.g., fusing welding electrodes, resistance welding electrodes) while applying heat and thereby melting the insulation coating is conventionally known (see, for example, Patent Document 2).

### RELATED DOCUMENT

### Patent Document

[Patent Document 1] JP Laid-open Patent Publication No. 2006-286385

[Patent Document 2] JP Laid-open Patent Publication No. 2000-277325

### SUMMARY OF THE INVENTION

However, in a case where an electric wire made of aluminum or the like is joined to a terminal by crimping connection involving pressurizing and heating the electric wire as in Patent Documents 1 and 2, the electric wire, which has lower strength than copper and the like, is sometimes broken due to the pressurizing, and therefore mechanical joining is undesirably weak. In addition, it is also necessary to secure conduction between the terminal and the electric wire and thereby achieve stable electric joining

Furthermore, using a watertight sealing structure to prevent electric corrosion as in Patent Document 1 increases the number of steps for joining between a terminal and an electric wire and complicates a terminal structure.

A purpose of the present invention is to provide a method for joining a terminal and an electric wire and a terminal for electric wire connection that make it possible to mechanically join the electric wire and the terminal firmly in an electrically stable state while avoiding occurrence of electric corrosion even in a case where the terminal and the electric wire are made of different materials.

In order to attain the purpose, a method for joining a terminal and an electric wire according to an embodiment of the present invention is a method for joining a terminal and an electric wire, in which the terminal having a connector part and an electric wire connection part is soldered onto the electric wire at the electric wire connection part, the electric wire being a bundle of a plurality of twisted wires, the terminal being made of a material different from the electric wire, and being surface-treated in order to avoid electric corrosion, the method including: providing, in the electric wire connection part, a first crimp piece that holds the electric wire under a stress condition where external force is applied and a second crimp piece that holds the electric wire under a stress-free condition where no external force is applied so that the first crimp piece and the second crimp piece are disposed apart from each other by a predetermined interval along a longitudinal direction of the electric wire; electrically joining the terminal and the electric wire together under the stress condition where external force is applied to the electric wire from the first crimp piece by crimping the first crimp piece; and crimping the second crimp piece to approach the electric wire so as not to apply external force to the electric wire, and soldering the electric wire onto the terminal by introducing a flux and solder to the electric wire from a gap between the electric wire and the second crimp piece while heating the electric wire under the stress-free condition by applying an electric current to a heating electrode, thereby mechanically joining the terminal and the electric wire.

According to the embodiment, the electric wire is electrically connected to the terminal by crimping the electric wire held by the first crimp piece under a stress condition where external force is applied so as to increase a joining density of the twisted wires, and the terminal and the electric wire are mechanically joined together by soldering the electric wire held by the second crimp piece onto the terminal while heating the electric wire under a stress-free condition where no external force is applied by applying an electric current to the heating electrode so as to increase the strength of joining between an outer peripheral surface of the electric wire and the terminal. Furthermore, the terminal that is made of a different material from the electric wire is surface-treated in order to avoid electric corrosion with the electric wire. It is therefore possible to join the electric wire and the terminal mechanically firmly in an electrically stable state while avoiding occurrence of electric corrosion even in a case where the terminal and the electric wire are made of different materials.

In the present invention, it is preferable that the method further includes soldering the twisted wires in part of the electric wire located between the first crimp piece and the second crimp piece by the flux and solder that are introduced into the second crimp piece and flow to the part of the electric wire between the first crimp piece and the second crimp piece while heating the part of the electric wire between the first crimp piece and the second crimp piece in a stress condition where external force is applied by the heating electrode. In this case, since the twisted wires are soldered between the first and second crimp pieces, the electric wire and the terminal can be mechanically joined together more firmly.

Furthermore, it is also preferable that the first crimp piece and the second crimp piece each has an electric wire containing part into which the electric wire is inserted; a cross sectional area of the electric wire containing part of the first crimp piece is smaller than that of the electric wire; and a cross sectional area of the electric wire containing part of the second crimp piece is larger than that of the electric wire. In this case, the electric wire that is held by the first crimp piece can be easily crimped under the stress condition, and the second crimp piece can be easily crimped under the stress-free condition where no external force is applied to the electric wire.

Preferably, the electric wire is made of aluminum or an aluminum alloy; and the terminal is made of copper or a copper alloy and a surface of the terminal is tin-plated. It is therefore possible to join the electric wire and the terminal mechanically firmly in an electrically stable state while avoiding occurrence of electric corrosion even in a case where the terminal and the electric wire are made of different materials.

Preferably, the second crimp piece has at least one penetrating portion that passes through the second crimp piece. Therefore, through the penetrating portion of the crimping piece, the flux and solder flow better and heat from the heating electrode more easily transmits to the electric wire. Furthermore, the second crimp piece has a cut-and-raised part obtained by raising a piece cut out from a bottom surface of the second crimp piece. This increases a contact area between the crimping piece and the twisted wires, thereby allowing heat from the heating electrode to more easily transmit to the inside between the twisted wires.

A terminal for electric wire connection according to another embodiment of the present invention is a terminal for electric wire connection that is surface-treated in order to avoid electric corrosion and is made of a material different from an electric wire that is a bundle of a plurality of twisted wires, the terminal including: a connector part; and an electric wire connection part onto which the electric wire is to be soldered. The electric wire connection part includes a first crimp piece that holds the electric wire under a stress condition where external force is applied and a second crimp piece that holds the electric wire under a stress-free condition where no external force is applied, the first crimp piece and the second crimp piece being disposed apart from each other by a predetermined interval along a longitudinal direction of the electric wire. The terminal and the electric wire are electrically joined together under the stress condition where external force is applied to the electric wire from the first crimp piece by crimping the first crimp piece. The terminal and the electric wire are mechanically joined together by crimping the second crimp piece to approach the electric wire so as not to apply external force to the electric wire, and soldering the electric wire onto the terminal by introducing a flux and solder to the electric wire from a gap between the electric wire and the second crimp piece while heating the electric wire under the stress-free condition by applying an electric current to a heating electrode.

According to the embodiment, the electric wire is electrically connected to the terminal by crimping the electric wire under a stress condition where external force is applied by the first crimp piece so as to increase a joining density of the twisted wires, and the terminal and the electric wire are mechanically joined together by soldering the electric wire onto the terminal while heating the electric wire under a stress-free condition where no external force is applied by the second crimp piece so as to increase the strength of joining between surfaces of the twisted wires and the terminal. Furthermore, the terminal that is made of a different material from the electric wire is surface-treated in order to avoid electric corrosion with the electric wire. It is therefore possible to join the electric wire and the terminal mechanically firmly in an electrically stable state while avoiding occurrence of electric corrosion even in a case where the terminal and the electric wire are made of different materials.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims.

In the accompanying drawings, like reference numerals are used to denote like parts throughout the several views, and:

FIG. 1A is a developed view illustrating a terminal for electric wire connection according to an embodiment of the present invention;

FIG. 1B is a perspective view illustrating the terminal for electric wire connection;

FIG. 1C is a perspective view illustrating a completed state of connection between the terminal and the electric wire;

FIG. 2 is a perspective view illustrating a state of joining between the terminal and the electric wire;

FIG. 3A is a perspective view illustrating a modification of a second crimp piece;

FIG. 3B is a perspective view illustrating a modification of the second crimp piece;

FIG. 3C is a perspective view illustrating a modification of the second crimp piece; and

FIG. 4 is a perspective view illustrating another modification of the second crimp piece.

### DESCRIPTION OF EMBODIMENTS

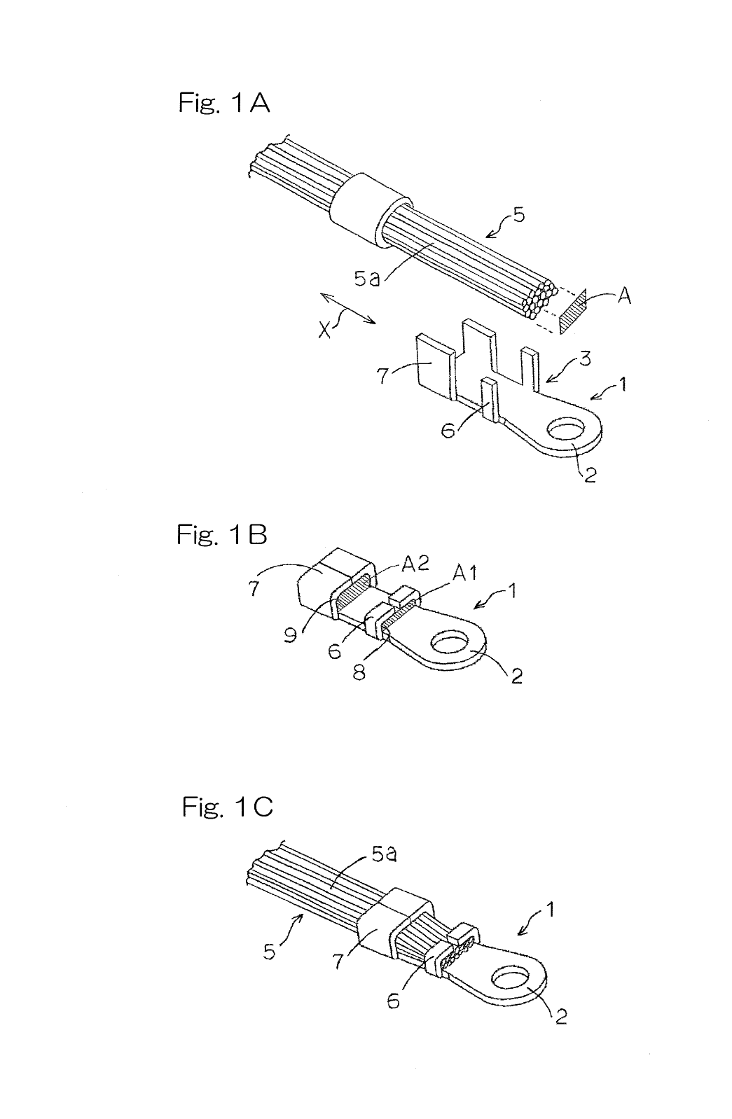

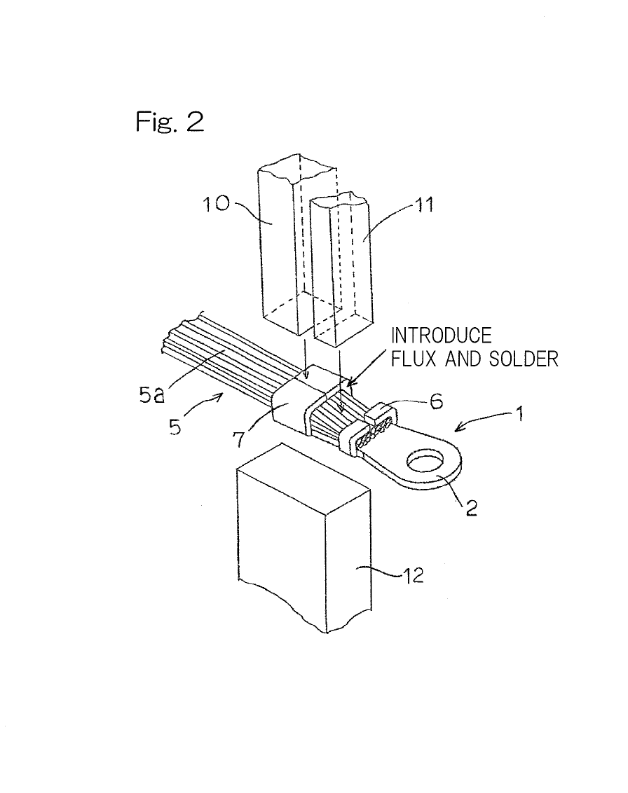

A preferred embodiment of the present invention is described below with reference to the drawings. FIG. 1A is a developed view illustrating a terminal for electric wire connection according to an embodiment of the present invention. FIG. 1B is a perspective view illustrating the terminal for electric wire connection, and FIG. 1C is a perspective view illustrating a completed state of connection between the terminal and the electric wire. FIG. 2 is a perspective view illustrating a state of joining between the terminal and the electric wire. As illustrated in FIG. 1A, a terminal 1 is made of a material different from an electric wire 5 and includes a connector part 2 and an electric wire connection part 3 for connecting the electric wire 5 by soldering. As illustrated in FIG. 1B, the electric wire connection part 3 includes a first crimp piece 6 and a second crimp piece 7. As illustrated in FIG. 1C, the electric wire 5 is joined to the terminal 1 in a state where the electric wire is held by the electric wire connection part 3. The connector part 2 and the electric wire connection part 3 are aligned in the same direction as a longitudinal direction X of the electric wire 5.

As illustrated in FIG. 2, a heating electrode such as a fusing welding electrode is made of tungsten and includes two upper electrodes 10 and 11 and a single lower electrode 12. The electric wire 5 and the terminal 1 are heated by application of electricity to the upper electrodes 10 and 11 and the lower electrode 12 while being nipped by the upper electrodes 10 and 11 and the lower electrode 12 from both upper and lower sides.

As illustrated in FIG. 1A, the electric wire 5 is, for example, a bundle of twisted wires made of aluminum or an aluminum alloy, and the terminal 1 is formed from a plate material made of a material, such as copper or a copper alloy such as brass, different from the electric wire 5, and a surface of the terminal 1 is tin-plated. This tin-plating of the surface makes it possible to avoid occurrence of electric corrosion even in a case where the terminal 1 and the electric wire 5 are made of different materials.

The electric wire connection part 3 includes the first crimp piece 6 that holds the electric wire 5 under a stress condition where external force is applied and the second crimp piece 7 that holds the electric wire 5 under a stress-free condition where no external force is applied. The first and second crimp pieces 6 and 7 have electric wire containing parts 8 and 9, respectively into which the electric wire 5 is to be inserted as illustrated in FIG. 1B. The electric wire containing parts 8 and 9 are formed by inwardly bending the first and second crimp pieces 6 and 7, respectively. The first and second crimp pieces 6 and 7 are provided so as to be apart from each other by a predetermined interval along the longitudinal direction X of the electric wire 5, and the first crimp piece 6 is disposed closer to a front end side of the electric wire 5.

As illustrated in FIG. 1B, a cross sectional area A1 of the electric wire containing part 8 of the first crimp piece 6 with respect to a cross sectional area A of the electric wire 5 is, for example, set to a range of A1≦0.85 A. That is, no gap exists between an inner peripheral surface of the electric wire containing part 8 of the first crimp piece 6 and an outer peripheral surface 5a of the electric wire 5. The electric wire 5 is strongly pressed against a top surface of the terminal 1 by crimping the first crimp piece 6, and thus the electric wire 5 is under a stress condition where external force is applied from the first crimp piece 6. This causes the twisted wires that constitute the electric wire 5 to make close contact with one another with no gap therebetween, thereby increasing a joining density of the twisted wires. As a result, the terminal 1 and the electric wire 5 are joined together in an electrically stable manner. Oxide coating is removed in advance from a front end part of the electric wire 5 made of aluminum or an aluminum alloy before the electric wire 5 is crimped by the first crimp piece 6.

The electric wire 5 that has been crimped by the first crimp piece 6 has some degree of mechanical strength which can serve as a provisional tacking so that, in fusing welding, the terminal 1 is held so as not to be detached from the electric wire 5 before crimping of the second crimp piece 7. After crimping of the second crimp piece 7 and soldering of the electric wire 5, the second crimp piece 7 exclusively bears mechanical strength, whereas the first crimp piece 6 bears almost no mechanical load and exclusively bears electric joining Meanwhile, as illustrated in FIG. 1B, a cross sectional area A2 of the electric wire containing part 9 of the second crimp piece 7 with respect to the cross sectional area A of the electric wire 5 is, for example, set to a range of 1.01 A≦A2≦1.05 A. That is, the setting is made such that an inner peripheral surface of the electric wire containing part 8 of the second crimp piece 7 and the outer peripheral surface of the electric wire 5 are spaced away from each other or slightly make contact with each other. The second crimp piece 7 is crimped to approach the electric wire 5 such that external force is not applied to the electric wire 5, and then a flux and solder are introduced into the electric wire 5 from the gap between the electric wire 5 and the second crimp piece 7 in a state where the electric wire 5 is heated under a stress-free condition by applying an electric current to the fusing welding electrodes 10 and 12 by a properly controlled amount and during a properly controlled period, as illustrated in FIG. 2. In this way, the electric wire 5 is soldered onto the terminal 1.

In this case, the electric wire 5 is held in a non-crimped state to such a degree that the electric wire 5 does not shake or wobble in the electric wire connection part 3 in a state where a gap exists between the inner peripheral surface of the crimping piece and the outer peripheral surface 5a of the electric wire 5 not by firmly crimping and fixing the electric wire 5 with the crimping piece, but by loosely bending the crimping piece along the outer shape of the bundle of twisted wires. It becomes easy to introduce the flux and solder from this gap. It is therefore possible to accomplish proper soldering while preventing breakage of the electric wire 5, which is made of aluminum or the like and is easy to break.

This allows the flux and the solder to spread throughout the entire outer peripheral surface 5a of the electric wire 5, thereby increasing the strength of joining between the outer peripheral surface 5a of the electric wire 5 and the terminal 1. As a result, the terminal 1 and the electric wire 5 are joined mechanically firmly. At this time, in the second crimp piece 7, the electric joining density is low because the flux and solder do not penetrate into the inside between the twisted wires, and therefore the second crimp piece 7 exclusively bears mechanical strength, while the first crimp piece 6 exclusively bears electric joining.

The terminal 1 and the electric wire 5 can be mechanically joined together more firmly by causing the upper electrode 11 and the lower electrode 12 of the fusing welding electrode to nip and pressurize part of the electric wire 5 that is located between the first and second crimp pieces 6 and 7, heating the part of the electric wire 5 under the stress condition where external force is applied by applying an electric current to the electrodes 11 and 12, and then soldering the twisted wires that constitute the part of the electric wire 5 between both crimping pieces 6 and 7, by the flux and solder introduced into the second crimp piece 7 and flowing to the part of the electric wire 5 between both crimping pieces 6 and 7, as illustrated in FIG. 2. Furthermore, part of the flux and solder also flows to the electric wire 5 inside the first crimp piece 6 and solders the twisted wires, thereby making it possible to improve mechanical joining strength. In this case, electric current application to the upper electrode 10 and the lower electrode 12 and electric current application to the upper electrode 11 and the lower electrode 12 may be performed at the same timing or may be performed at different timings.

As described above, in the present invention, part of an electric wire that is held by a first crimp piece is crimped under a stress condition where external force is applied, to increase a joining density of twisted wires and electrically join the electric wire and a terminal, and part of the electric wire that is held by a second crimp piece is soldered onto the terminal while being heated in a stress-free condition where no external force is applied by applying an electric current for a fusing welding, to increase the strength of joining between an outer peripheral surface of the electric wire and the terminal and mechanically join the terminal and the electric wire together. Furthermore, the terminal made of a material different from the electric wire is surface-treated in order to avoid electric corrosion with the electric wire. This makes it possible to join the electric wire and the terminal mechanically firmly in an electrically stable state while avoiding occurrence of electric corrosion even in a case where the terminal and the electric wire are made of different materials.

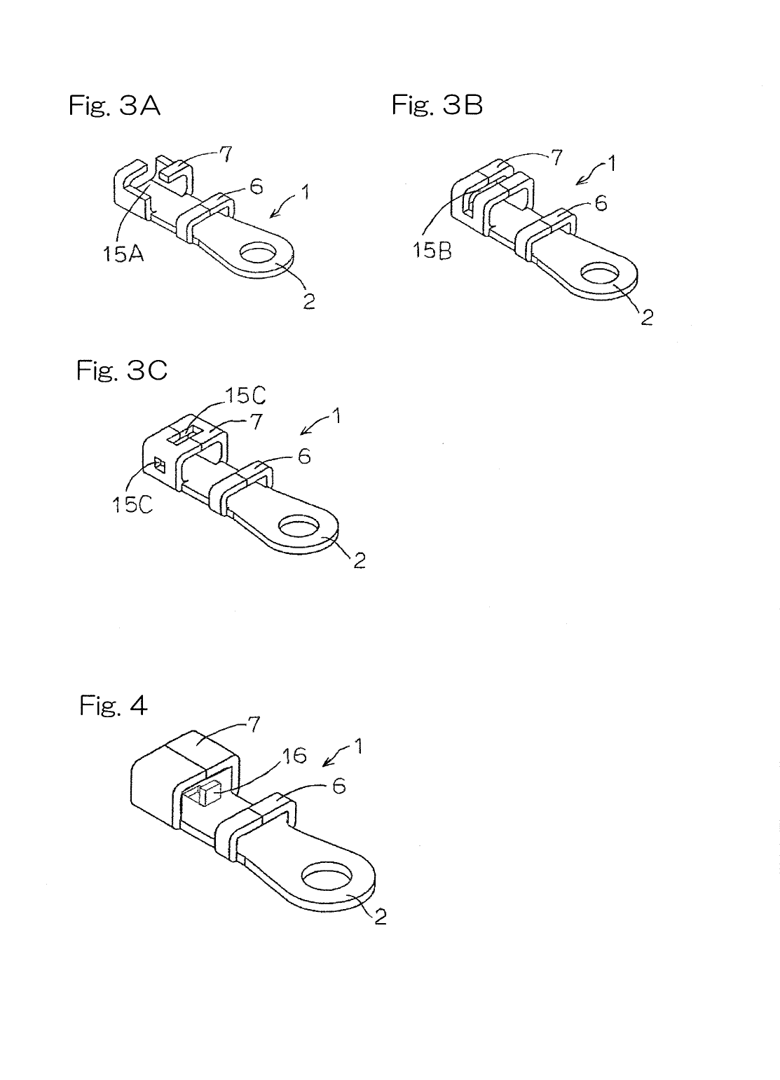

FIGS. 3A through 3C are perspective views illustrating modifications of the second crimp piece 7. The second crimp piece 7 has respectively a penetrating portion (15A˜15C) that passes through the crimp piece 7. The number of each of the penetrating portions 15A˜15C may be more than one. Other configurations are similar to those in First Embodiment. In FIG. 3A, the second crimp piece 7 has, on a top surface thereof, a penetrating portion 15A that has a substantially L shape in plan view. In this case, the fusing welding electrode can make direct contact with the electric wire 5. In FIG. 3B, the second crimp piece 7 has, from a top surface to a side surface thereof, a slit-like penetrating portion 15B. In FIG. 3C, the second crimp piece 7 has, on a top surface and a side surface thereof, a plurality of penetrating portions 15C. In these modifications, through the penetrating portion 15 of the second crimp piece 7, the flux and solder flow better and heat applied by the fusing welding electrode more easily transmits to the electric wire 5.

As illustrated in FIG. 4, the second crimp piece 7 has a cut-and-raised part 16 obtained by raising a piece cut out from a bottom surface. Because of the cut-and-raised part 16, the twisted wires are brought closer to the inner peripheral surface of the crimp piece, thereby increasing a contact area between the second crimp piece 7 and the twisted wires and making it easier for heat applied by the fusing welding electrode to transmit to the inside between the twisted wires.

In each of the embodiments, an electric wire is heated by using a fusing welding electrode as a heating electrode. However, an electric wire may be heated by using a resistance welding electrode.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . terminal for electric wire connection

2 . . . connector part

3 . . . electric wire connection part

5 . . . electric wire

6 . . . first crimp piece

7 . . . second crimp piece

8 . . . electric wire containing part of first crimp part

9 . . . electric wire containing part of second crimp part

10 . . . upper electrode (heating electrode)

11 . . . upper electrode (heating electrode)

12 . . . lower electrode (heating electrode)

15A˜15C . . . penetrating portion

16 . . . cut-and-raised part

What is claimed is:

1. A method for joining a terminal and an electric wire, in which the terminal having a connector part and an electric wire connection part, is soldered onto the electric wire at the electric wire connection part, the electric wire being a bundle of a plurality of twisted wires, the terminal being made of a material different from the electric wire, and being surface-treated in order to avoid electric corrosion, the method comprising:
providing, in the electric wire connection part, a first crimp piece that holds the electric wire under a stress condition where external force is applied and a second crimp piece that holds the electric wire under a stress-free condition where no external force is applied, so that the first crimp piece and the second crimp piece are disposed apart from each other by a predetermined interval along a longitudinal direction of the electric wire;
electrically joining the terminal and the electric wire together under the stress condition where external force is applied to the electric wire from the first crimp piece by crimping the first crimp piece; and
crimping the second crimp piece to approach the electric wire so as not to apply external force to the electric wire, and soldering the electric wire onto the terminal by introducing a flux and solder to the electric wire from a gap between the electric wire and the second crimp piece while heating the electric wire under the stress-free condition by applying an electric current to a heating electrode, thereby mechanically joining the terminal and the electric wire.

2. The method for joining the terminal and the electric wire as claimed in claim 1, further comprising soldering the twisted wires in part of the electric wire located between the first crimp piece and the second crimp piece by the flux and solder that are introduced into the second crimp piece and flow to the part of the electric wire between the first crimp piece and the second crimp piece while heating the part of the electric wire between the first crimp piece and the second crimp piece in a stress condition where external force is applied by the heating electrode.

3. The method for joining the terminal and the electric wire as claimed in claim 2, wherein
the first crimp piece and the second crimp piece each has an electric wire containing part into which the electric wire is inserted;
a cross sectional area of the electric wire containing part of the first crimp piece is smaller than that of the electric wire; and
a cross sectional area of the electric wire containing part of the second crimp piece is larger than that of the electric wire.

4. The method for joining the terminal and the electric wire as claimed in claim 2, wherein
the electric wire is made of aluminum or an aluminum alloy; and
the terminal is made of copper or a copper alloy and a surface of the terminal is tin-plated.

5. The method for joining the terminal and the electric wire as claimed in claim 2, wherein
the second crimp piece has at least one penetrating portion that passes through the second crimp piece.

6. The method for joining the terminal and the electric wire as claimed in claim 2, wherein
the second crimp piece has a cut-and-raised part obtained by raising a piece cut out from a bottom wall of the electric wire connection part of the second crimp piece.

7. A terminal for electric wire connection that is surface-treated in order to avoid electric corrosion and is made of a material different from an electric wire that is a bundle of a plurality of twisted wires, the terminal comprising:
a connector part; and
an electric wire connection part onto which the electric wire is to be soldered, wherein
the electric wire connection part includes a first crimp piece that holds the electric wire under a stress condition where external force is applied and a second crimp piece that holds the electric wire under a stress-free condition where no external force is applied, the first crimp piece and the second crimp piece being disposed apart from each other by a predetermined interval along a longitudinal direction of the electric wire,
the terminal and the electric wire are electrically joined together under the stress condition where external force is applied to the electric wire from the first crimp piece by crimping the first crimp piece, and
the terminal and the electric wire are mechanically joined together by crimping the second crimp piece to approach the electric wire so as not to apply external force to the electric wire, and soldering the electric wire onto the terminal by introducing a flux and solder to the electric wire from a gap between the electric wire and the second crimp piece while heating the electric wire under the stress-free condition by applying an electric current to a heating electrode.
